(19) United States
(12) Patent Application Publication
(10) Pub. No.: US 2023/0365235 A1
(43) Pub. Date: Nov. 16, 2023

(54) WATERSPORTS BOARD AND METHOD OF MAKING

(71) Applicant: AHI Board LLC, Goleta, CA (US)

(72) Inventors: Matthew S. Van Dyk, Santa Barbara, CA (US); Aaron K. Foster, Santa Barbara, CA (US)

(73) Assignee: AHI Board LLC, Goleta, CA (US)

(21) Appl. No.: 18/313,276

(22) Filed: May 5, 2023

Related U.S. Application Data
(60) Provisional application No. 63/340,104, filed on May 10, 2022.

(51) Int. Cl. B63B 32/59; B63B 32/40; B63B 32/70; B29C 44/34

(52) U.S. Cl. CPC B63B 32/59; B63B 32/40; B63B 32/70; B29C 44/3434

(57) ABSTRACT

A sports board formed of expanded polypropylene (EPP) foam and a method for making the sports board using a steam-chest molding process includes molding the sports board to finished shape, such that no post-molding processing of the board is required, and such that the sports board is of monolithic construction and fully recyclable. The molding process is configured to form a continuous exterior skin of the board, to resist water ingression, the exterior skin including one or more purchase surface areas, each purchase surface area including a plurality of protrusion clusters, each protrusion cluster formed by controlled extrusion of the EPP foam into steam vents distributed in a predefined pattern within the mold cavity to form steam vent markings. The molding process is configured such that selected areas of the board surface are contoured for undisrupted water flow over the board and to resist breakage or chipping in use.

### CROSS-REFERENCE TO RELATED APPLICATIONS

This application claims the benefit of U.S. Provisional Application No. 63/340,104, filed May 10, 2022, which is hereby incorporated by reference in its entirety.

### TECHNICAL FIELD

The present disclosure pertains to water sports board riding equipment and methods of making water sports board riding equipment.

### BACKGROUND

Board riding on water has been used for various sports and/or activities such as, for example, surfing, bodyboarding, bodysurfing, wakeboarding, riverboarding, riding waves, and being towed behind a boat. A water sports board is generally understood to be a buoyant device made of wood, foam, plastic, fiberglass, carbon fiber, epoxy resins, and/or various combinations thereof, used to aid the rider while traveling on the surface of the water. Many of the materials currently used to form water sports boards can be toxic to very toxic to the environment and when used in combination with one another can be very difficult to recycle, or in combination, cannot be recycled.

In use, riders of water sports boards must maintain purchase (firm hold, grip and/or position) on the board throughout the ride or they may fall, crash, lose their balance, or ability to perform maneuvers or tricks. Riders can maintain purchase through various methods and products such as straps, handles, applied waxes, grips, and/or textures applied to and/or formed into the board. The board surfaces may be textured during manufacturing, for example, by stamping, etching, cutting, or other texture forming processes.

In some instances, the same devices or solutions designed to aid the purchase of a rider can also create problems for the rider such as interference to the rider's position which can be unique to each rider and/or to each ride, or textured surfaces or waxes can cause irritation or chafing of the skin of the rider during use. Riders will sometimes sacrifice purchase to alleviate interference or irritation from these methods or devices.

Expanded polypropylene foam (EPP) has been used to create watersports equipment as disclosed in U.S. Pat. No. 4,961,715. EPP is a foam manufactured using steam-chest molding practices, where polypropylene (PP) beads are inserted into a mold cavity through fill guns. Steam is introduced into the mold cavity, and the PP beads expand as a result of being exposed to steam. After bead expansion, the steam is then released from the mold through steam vents installed into the mold. The bodyboard part is then removed from the tooling using ejector pins and placed in an oven to cure. During the steam-chest molding process, various witness marks are formed on the surface of the molded board, by the steam vents, fill gun heads (nozzles), and ejector pins. The witness marks can be of various depths and heights, which can, depending on location, size and shape, alter a board's surface and can leave the board with undesired aesthetical properties and/or can impede or interfere with the flow of water across the board which can slow a rider or alter the performance of the board.

A cured EPP water sports board, although very light and durable, can be damaged during prolonged storage or when on display for sale when the weight of the board is left to rest on the tail, nose, or small surface area of the board. During steam-chest molding, the outer layer of foam beads creates a “skin” that helps with the durability of the board as well as water intrusion. EPP is a closed-cell foam but can absorb water with prolonged submersion especially when the skin of the molded part is damaged or manipulated when attaching accessories such as leashes, cameras, fins, straps, or handles, or by stamping or press-forming after molding to add surface textures, etc. A known practice to overcome the susceptibility of foam boards to water absorption and damage, and to provide a smooth surface covering the molded witness marks, is the addition of a polymer or resin coating or shell, applied, sprayed, or molded onto the foam board in a typical construction. However, the addition of the applied coating, and/or molded shell adds weight and cost to the board, and also reduces and/or eliminates the ability to recycle the board efficiently.

### SUMMARY

A sports board and method of forming the sports board is provided herein. In an illustrative example, the sports board is configured as a water sports board suitable for use as a wave riding device or for use as any of water, snow, or sand sports equipment. Water sports boards can range in size from 6″ hand planes to 12′0″ surfboards or paddleboards. In a non-limiting example, the accompanying drawings illustrate a water sports board configured as a bodyboard. The water sports board can also be referred to herein as a bodyboard. It should be understood that the example of a bodyboard and/or the use of the term bodyboard interchangeably with the term water sports board or sports board in the description is non-limiting, such that each term is intended to include all types, shapes and sizes of sports boards including water sports boards and bodyboards.

The sports board described herein is advantaged by being molded of a single material, expanded polypropylene (EPP) foam, without any over molding, coating, shell, or adhesives, such that the EPP foam board is fully recyclable. Further, the steam-chest molding process used to form the board is configured such that, during molding of the board, clusters of protrusions are intentionally formed on the board's as-molded exterior surface by extrusion of the EPP material into vent apertures of steam vents positioned in the mold cavity, where the clusters of protrusions are configured, positioned and designed to define integral purchase surface areas on the exterior surfaces of the board. As such, the clusters of protrusions, which in a typical molding operation may be considered molding defects or detrimental to the appearance or surface characteristics of a typical molded product, are instead intentionally and advantageously formed on the exterior surface of the board as disclosed herein, to form one or more integral purchase surface areas as a functional feature of the finished board. Further, the mold cavity and components are configured such that the board is molded to form a continuous skin, absent any perforations or sharp corners or edges, advantageously enhancing fluid flow over the board surface, and, as a continuous skin, sealing the board against water ingression during use. In one example, the tail portion of the board includes a contoured tail feature, shaped to provide a resting surface for the board when stored in an upright position and without any sharp edges, such that the contoured tail feature resists damage and breakage of the type which could be incurred during upright storage if the tail feature terminated in a sharp edge. The board including the one or more integral purchase surface areas is fully formed in the mold cavity, such that no post-molding processing is required to seal or texture the surface of the board, providing a cost advantage in manufacturing, and a relatively lighter weight board as compared with boards of similar size including a molded shell or overcoating.

The above features and other features and advantages of the present invention are readily apparent from the following detailed description of the best modes for carrying out the invention when taken in connection with the accompanying drawings.

### BRIEF DESCRIPTION OF THE DRAWINGS

The description herein makes reference to the accompanying drawings wherein like reference numerals refer to like or similar components throughout the several views, and wherein:

FIG. 1 shows a schematic front perspective image of a group of water sports boards including a perspective top view of a bodyboard;

FIG. 2 shows a schematic image of a side view of the bodyboard of FIG. 1;

FIG. 3 schematically shows a perspective top view of the bodyboard of FIG. 1;

FIG. 4 schematically shows a perspective bottom view of the bodyboard of FIG. 1;

FIG. 5 schematically shows top, side and end views of the bodyboard of FIG. 1;

FIG. 6 is a schematic cross-sectional view of a steam-chest molding process including a mold cavity configured for making the bodyboard of FIG. 1;

FIG. 7 is a schematic flowchart of a method for making the bodyboard of FIG. 1;

FIG. 8 is a schematic perspective bottom view of a bodyboard made using flat (non-contoured) ejector pins and flat (non-contoured) injection heads;

FIG. 9 is a schematic perspective bottom view of the bodyboard of FIG. 1 made using contoured ejector pins and contoured injection heads;

FIG. 10 is a schematic partial view of the bottom surface of the nose portion of the bodyboard of FIG. 9 showing an ejector pin marking made by a contoured ejector pin;

FIG. 11 schematically shows rear perspective cross-sectional view of a tail portion of the bodyboard of FIG. 1, including a contoured tail feature;

FIG. 12 is a schematic side view of the tail portion of the bodyboard of FIG. 1, including the contoured tail feature;

FIG. 13 is a schematic front partial view of a top deck of the bodyboard of FIG. 1, including a leash plug hole and a debossed marking configured as a logo;

FIG. 14 is a schematic partial view of the top deck of the bodyboard of FIG. 13, showing an enlarged view of the leash plug hole;

FIG. 15 is a schematic perspective view of the bottom surface of the bodyboard of FIG. 10, showing an injector head marking and a plurality of vent markings defining at least one purchase surface area, and an enlarged view of one of the vent markings;

FIG. 16 schematically shows a cross-section A-A of the enlarged vent marking of FIG. 15, the vent marking including a plurality of protrusions;

FIG. 17 is a schematic perspective image of a portion of the top deck of the bodyboard of FIG. 1, including a plurality of microvent markings formed on the top deck surface, and enlarged views of one of the microvent markings;

FIG. 18 is an schematic perspective view of a portion of the bottom surface of the bodyboard of FIG. 13, showing an ejector pin marking and a plurality of vent markings distributed in a pattern defining at least one purchase surface area, and further including an enlarged view of one of the vent markings shown in color and black and white;

FIG. 19 is a schematic bottom view of a portion of the bottom surface of the bodyboard of FIG. 18 showing the distribution of vent markings in a pattern defining a purchase surface area;

FIG. 20 is a grouping of schematic images of exemplary vents which can be used to form vent markings on the surfaces of the bodyboard of FIG. 1, during molding of the bodyboard using the method as illustrated in FIGS. 6 and 7.

### DETAILED DESCRIPTION

While the present disclosure may be described with respect to specific applications or industries, those skilled in the art will recognize the broader applicability of the disclosure. Those having ordinary skill in the art will recognize that terms such as “above,” “below,” “upward,” “downward,” etc., are used descriptively of the figures, and do not represent limitations on the scope of the disclosure, as defined by the appended claims. Any numerical designations, such as “first” or “second” are illustrative only and are not intended to limit the scope of the disclosure in any way.

The terms “comprising,” “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

The terms “a,” “an,” “the,” “at least one,” and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

A sports board 100 and method 200 of forming the board 100 is provided herein. In an illustrative example, the sports board 100 is configured as a water sports board suitable for use as a wave riding device or for use as any of water, snow, or sand sports equipment. Water sports boards can range in size from 6″ hand planes to 12′0″ surfboards or paddleboards. In a non-limiting example, the accompanying drawings illustrate a water sports board configured as a bodyboard 100. It should be understood that the example of a bodyboard and/or the use of the term bodyboard interchangeably with the term water sports board or sports board in the description is non-limiting, such that each of the terms sports board, water sports board, bodyboard, and/or board 100 is intended to include all types, shapes and sizes of sports boards including water sports boards and bodyboards.

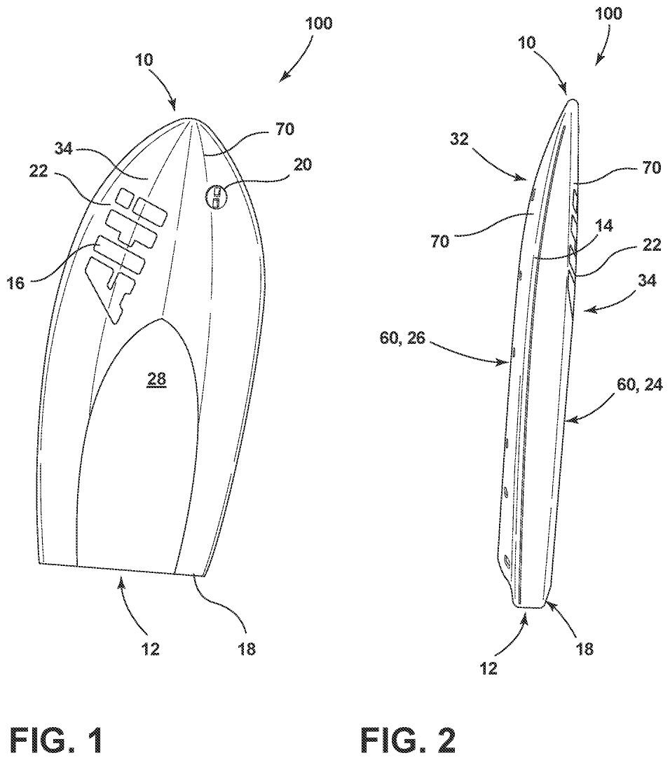

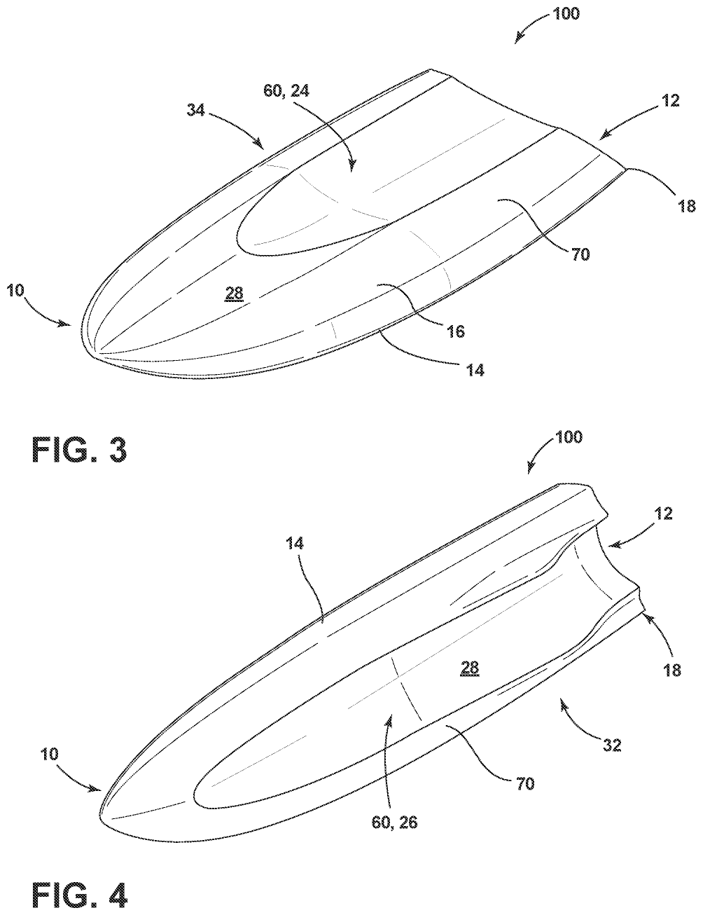

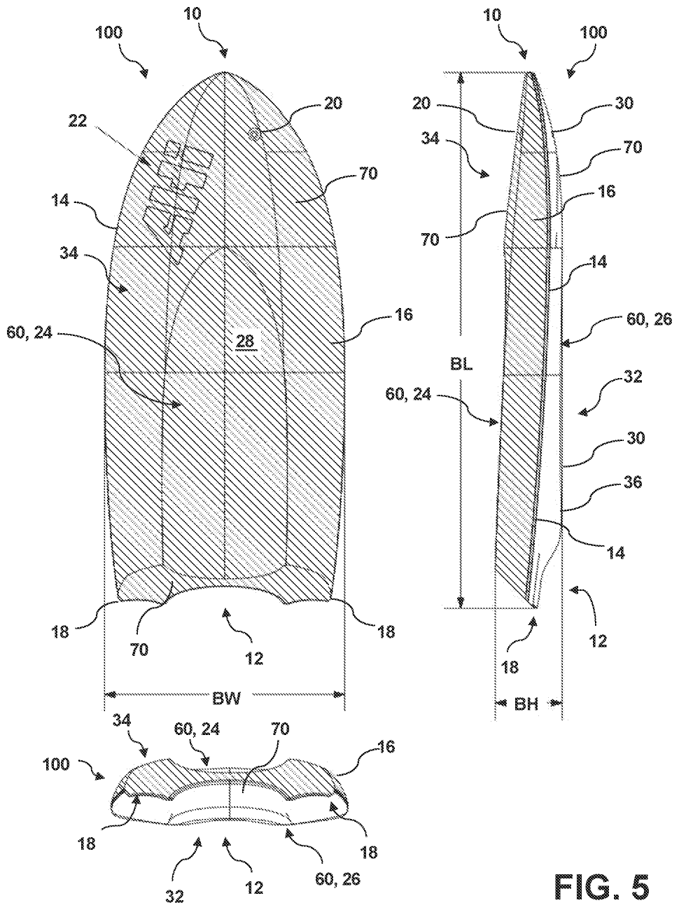

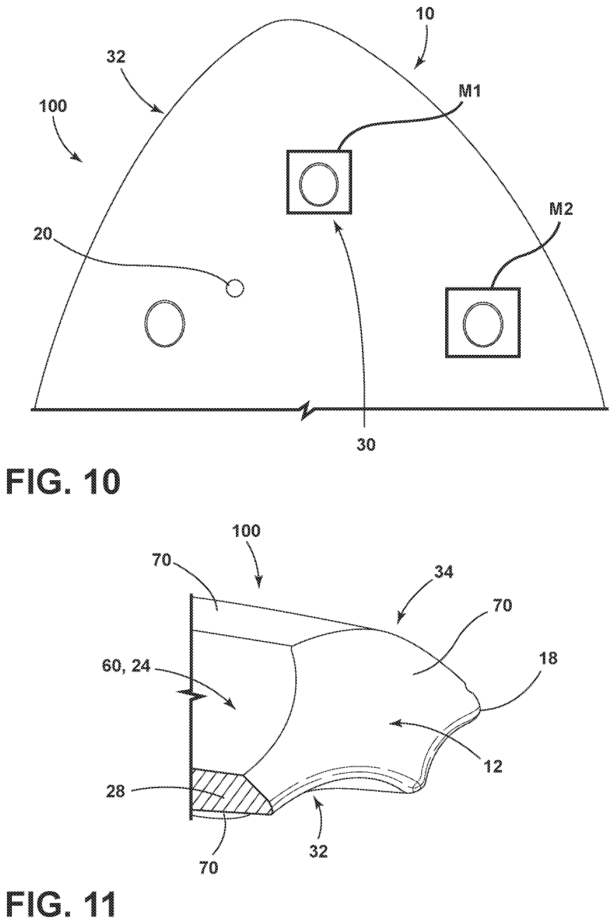

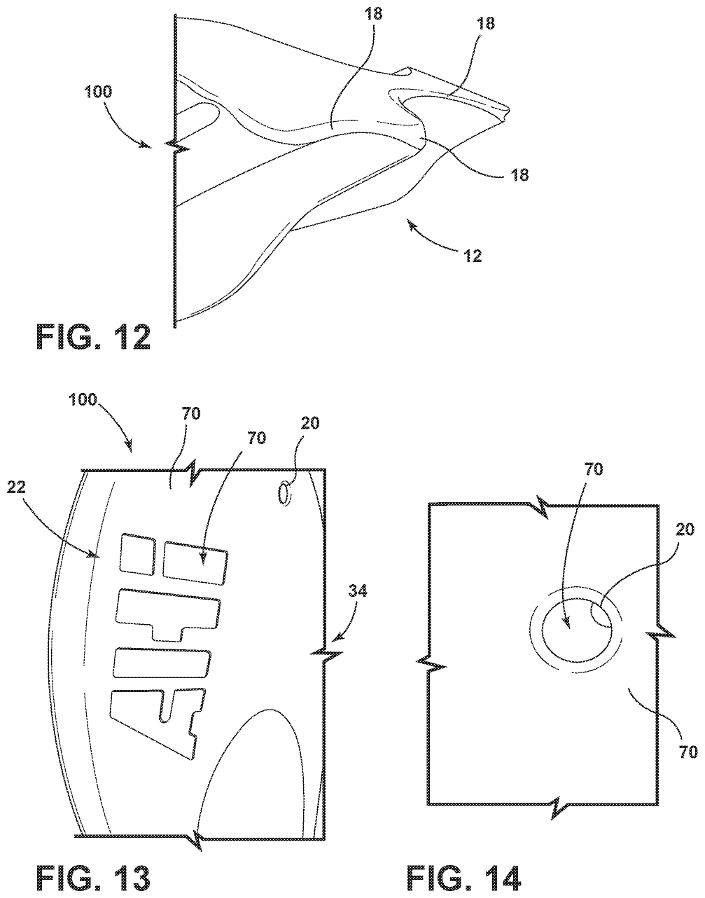

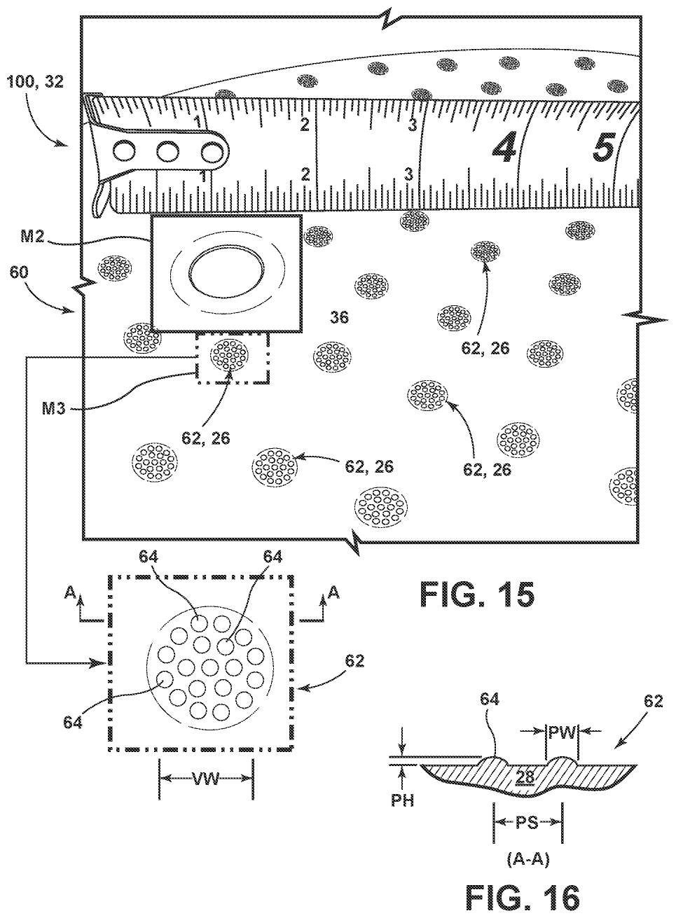

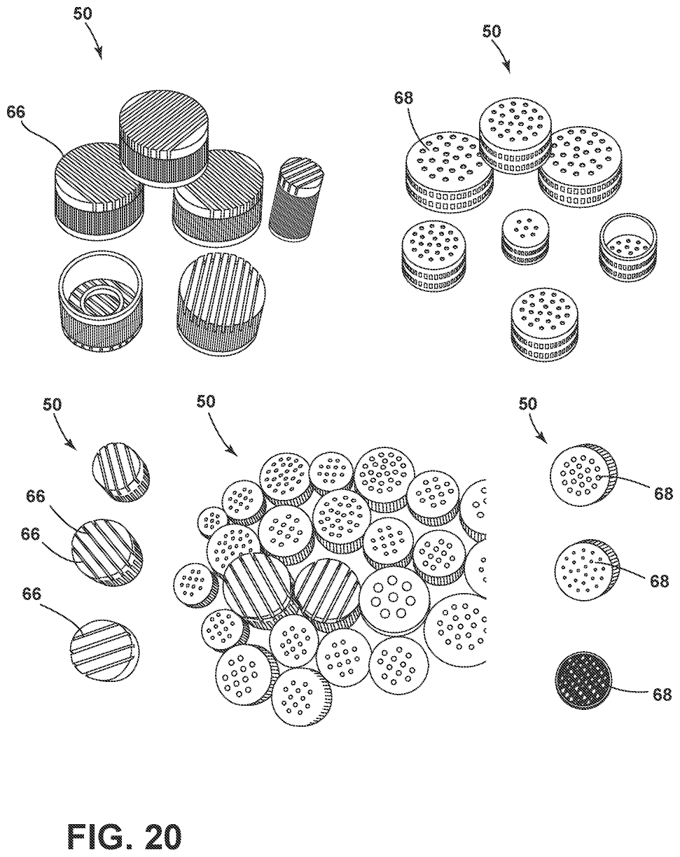

Referring to the drawings wherein like reference numbers represent like components throughout the several figures, the elements shown in FIGS. 1-20 are not necessarily to scale or proportion. Accordingly, the particular dimensions and applications provided in the drawings presented herein are not to be considered limiting. Referring to FIGS. 1-5, a schematic perspective image of a plurality of bodyboards 100 formed by the method 200 described herein is shown in FIG. 1, and a schematic perspective side image of a side view of one of the bodyboards 100 is shown in FIG. 2. Schematic illustrations of the top deck 34 and bottom surface 32 of the board 100 are shown in FIGS. 3 and 4, and top, side and edge views of the board 100 are shown schematically in FIG. 5. The bottom surface 32 can also be referred to herein as the bottom 32 of the board 100. As shown in the drawings and seen in FIG. 2, a contoured edge rail 14 is intermediate the top deck 34 and bottom 32 of the board 100. In the illustrative example shown, the bodyboard 100 includes the top deck 34 and the bottom 32, and a continuous exterior skin 70. The board 100 includes a nose 10, a tail 12 and sides 16. The exterior skin 70 includes one or more purchase surface areas 60 which provide a gripping surface to create purchase for a user of the board 100. The purchase surface areas 60 include and/or are defined by a plurality of protrusion clusters 62 formed in the exterior skin 70 of the board 100, by extrusion of the EPP foam 28 into apertures 68 (see FIG. 20) in steam vents 50 of the mold cavity 46, during molding of the board 100. The protrusion clusters 62, in a non-limiting example, can include microvent markings 24 and/or steam vent markings 26, each including a plurality of domed protrusions 64, as shown in FIGS. 15-19 formed using steam vents 50 having a plurality of vent apertures 68 as shown in FIG. 20, and/or can include other steam vent markings and/or protrusions 64 such as ridges formed using steam vents 50 shown in FIG. 20 including slotted apertures 66, or combinations of these. Microvent markings 24 and steam vent markings 26 can be referred to collectively herein as vent markings. The protrusion clusters 62 can be distributed randomly within a purchase surface area 60 and/or can be positioned and/or arranged in a pattern, to provide different purchase characteristics at different purchase surface areas 60 on the board 100, according to the anticipated use of the board, as further described herein.

The board 100 is characterized by a board width BW, a board length BL, and a board height BH. In non-limiting examples, the board length can range in size from about 6 inches for a hand plane to about 12 feet for surfboards or paddleboards. In a non-limiting example, the board 100 is configured as a bodyboard having a board width BW in a range of about 20 to 22 inches, a board length BL in a range of about 44 to 46 inches, and a board height BH in a range of about 4 to 6 inches.

In an illustrative example, the board 100 has a board width BW in a range of about 6 to 18 inches, and a board length in a range of about 6 to 18 inches, such that the board 100 can be configured for use, in a non-limiting example, as a handplane. In an illustrative example, the board 100 has a board width BW in a range of about 20 to 36 inches, and a board length in a range of about 32 to 50 inches, such that the board 100 can be configured for use, in a non-limiting example, as a bodyboard. In an illustrative example, the board 100 has a board width BW in a range of about 20 to 48 inches, and a board length in a range of about 40 to 100 inches, such that the board 100 can be configured for use, in a non-limiting example, as a surfboard. In an illustrative example, the board 100 has a board width BW in a range of about 20 to 36 inches, and a board length in a range of about 44 to 46 inches, such that the board 100 can be configured for use, in a non-limiting example, as a rescue sled, such as a watercraft rescue sled used to be towed behind watercraft such as a jet ski to pick up a person from tow-surfing and step-off surfing, or for water rescue events, for example, by a lifeguard or water rescue personnel.

The board 100 is made of expanded polypropylene (EPP) foam 28 by molding using a steam chest molding process 200 as further described herein, such that the board 100 is a monolithic structure, formed by a method of monolithic construction, being formed completely of EPP foam including the exterior skin 70 formed of EPP foam during the steam chest molding process 200, such that the board 100, as molded and cured, is finished for use and does not require any subsequent processing. The term “monolithic structure” as used herein to refer to the board 100, refers to a structure which is formed of a single homogeneous material, in the present example, EPP foam 28, as a unitary component, e.g., in a single continuous piece of EPP foam 28 including a continuous exterior skin 70 comprising the EPP foam 28, the continuous exterior skin 70 defining the shape of the unitary component. The term “monolithic construction” as used herein to refer to the method 200 of forming the board 100, refers to a process where, using a single homogeneous material, in the present example, EPP beads processed (expanded, softened and fused) to form EPP foam 28, the board is fully constructed, in the present example, by molding the board 100 using steam chest molding to form the board 100 and surface features of the board 100 as further described herein, and curing the board, such that after curing, the molded EPP board 100 is a finished product having a monolithic structure, and is not subject to, and does not require, any subsequent processing. As such, the monolithic construction of the board 100 provides the advantages of relatively lower manufacturing and material costs, by using only one material, EPP beads molded to form EPP foam, by not requiring any coating or shell to encapsulate the foam such that the monolithic structure, e.g., the board 100 is lighter weight than a coated board of comparable size, and by not requiring any subsequent processing such as cutting, drilling, stamping or pressing the foam material to add features to the board such as leash plug holes, logos, surface texturing, etc., as these are all molded into the board during the molding process described herein. The monolithic construction of the board 100 forms a continuous exterior skin 70 which is compressed during molding such that the continuous exterior skin 70 is highly resistant to water absorption, eliminating the need to add an overcoat or shell to the board 100 to prevent water absorption. Advantageously, the board 100, as further described herein, is formed without any sharp edges, sharp corners, or sharp markings, as these features, if formed into the board, would be relatively more susceptible to breakage, chipping, and/or providing a water absorption path. Contoured features of the board 100 include a contoured edge rail detail 14, a contoured tail edge feature 18, a debossed logo marking 22, a contoured leash plug hole 20, contoured ejection pin markings 30 and contoured injector head markings 36, each of which are contoured to increase resistance to water ingression and to decrease susceptibility to damage to the exterior skin 70 at these feature locations, and such that in use, the flow of water, snow, sand, etc. over the exterior skin 70 of the board 100 is not affected by and/or minimally impeded by the contoured features.

In a non-limiting example, as shown in FIGS. 1 and 13, polypropylene (PP) beads of various colors can be used to form the EPP foam 28 of the board 100, to produce boards 100 of various colors, combinations of different colored beads, and/or color patterns. The colored boards 100 are aesthetically pleasing and visually attractive, and further distinguish the EPP foam 28 from boards made of expanded polystyrene (Styrofoam) which is typically molded in white and which does not provide the resistance to water absorption or the resistance to impact damage of the EPP foam board 100 described herein. Advantages of the use of PP beads of various colors to form the board 100 include the capability to customize the color and/or color pattern of a board 100 to a user's specifications, and to directly mold a colored board 100 such that no post-molding coloring process, such as dyeing, coating or painting the board 100 is required after molding to colorize the EPP foam 28, and such that recyclability of the board 100 is not detrimentally affected by the addition of dyes, coatings, paint or similar coating or colorizing materials.

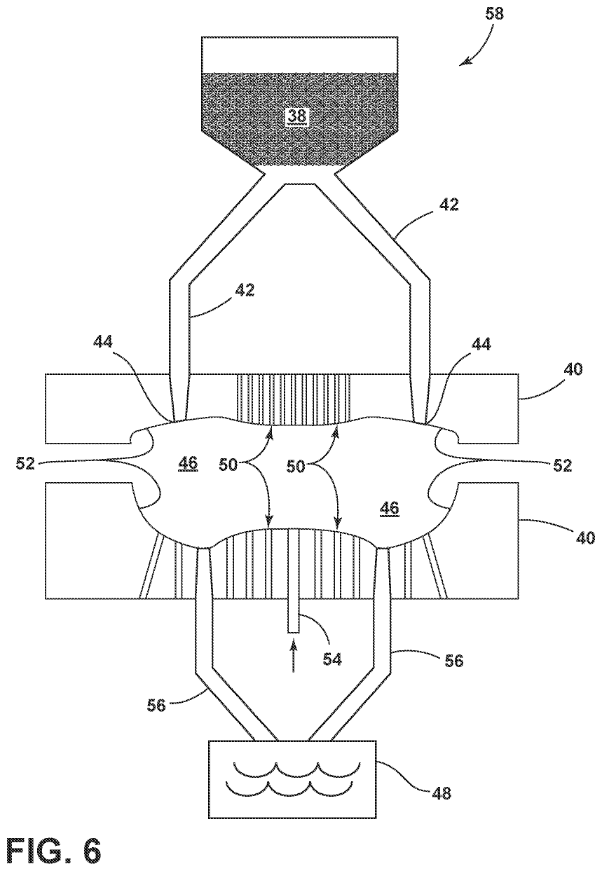

Referring to FIGS. 6-10, 15 and 18, a method for forming the board 100 using a steam chest molding process is described herein. The monolithic construction method of forming the board 100 using the steam chest molding process is distinguished by controlling certain molding parameters and mold characteristics to yield a combination of performance and functional characteristics of the board 100 having a monolithic structure including the lightweight, the expanded bead characteristics of the exterior skin 70 which function to resist water absorption into the board 100 when in use and define a portion of the surface texture of the board 100, flashless or minimal flash formation at the mold parting line included in the edge rail 14, the flow and/or extrusion of the EPP material 28 into the steam vent 50 apertures 68 to form protrusions 64 on the exterior skin 70 in various sizes and patterns, material flow of the EPP material 28 within the mold cavity 46 to form the contoured features, including controlling the injector head and ejector pin configurations and pressures to minimize witness markings 30, 36 in the board 100 from these tooling components. FIG. 6 shows a non-limiting example of a molding press 58, configured as a steam chest molding press, for forming the board 100. The molding press 58 includes mold comprising mold halves 40, which are shown in an open condition in FIG. 6, and which include mold cavity surfaces 52 such that the mold halves 40, in a closed condition, form a mold cavity 46 defined by the mold cavity surfaces 52. In the example shown, the upper mold half 40 (as shown in FIG. 6) includes a mold cavity surface 52 which corresponds to and defines the bottom surface 32 of the board 100. Likewise, in the example shown, the lower mold half 40 (as shown in FIG. 6) includes a mold cavity surface 52 which corresponds to and defines the top deck 34 of the board 100. The mold halves 40, in a closed position, define a parting line which corresponds to the edge rail detail 14 and, in a non-limiting example, the contoured tail feature 18. In the example shown, the upper mold half includes PP fill nozzles 42, which can also be referred to herein as PP fill guns 42, for feeding the non-expanded PP beads 38 into the mold cavity 46. The upper mold half 40 further includes a plurality of steam vents 50 for releasing steam from the mold cavity 46 and for forming protrusion clusters 62 on the exterior skin 70 of the board 100 during molding of the board 100. In the example shown, the lower mold half includes steam nozzles 56 for feeding high pressure steam 48 into the mold cavity 46, and one or more ejector pins 54 which are actuable to push (eject) the finished molded board 100 away from the mold cavity surface 52 and/or out of the mold cavity 46, after molding of the board 100 is completed. The steam nozzles 56, fill gun heads 44 and ejector pins 54 are contoured to conform to the exterior shape of the board 100, to minimize any markings to the exterior skin 70 of the board 100 during the forming process. Additionally, the ejector pin pressure can be controlled and/or minimized to minimize marking of the exterior skin 70 during ejection of the board 100 from the mold.

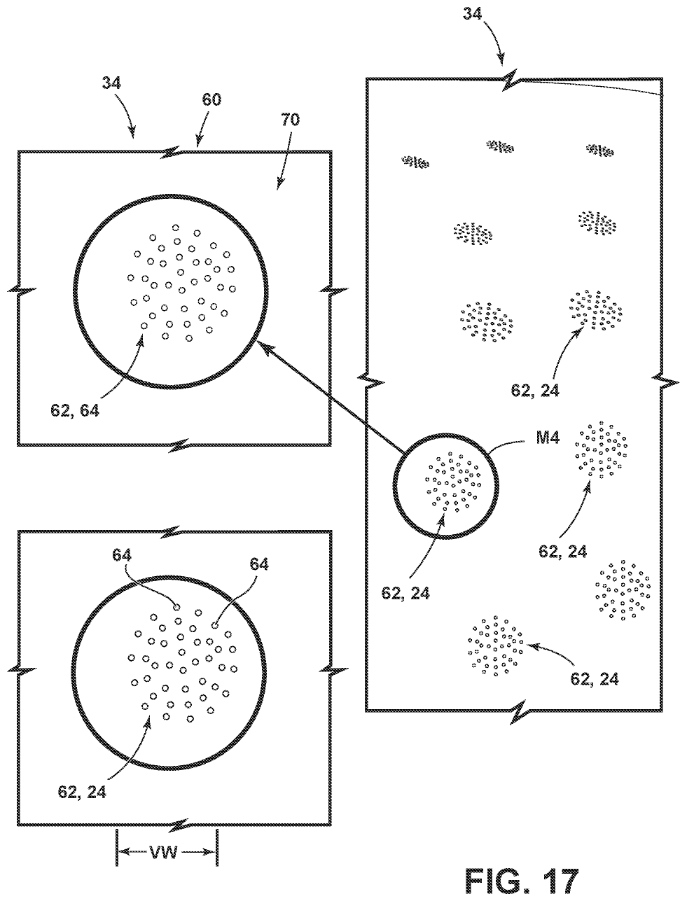

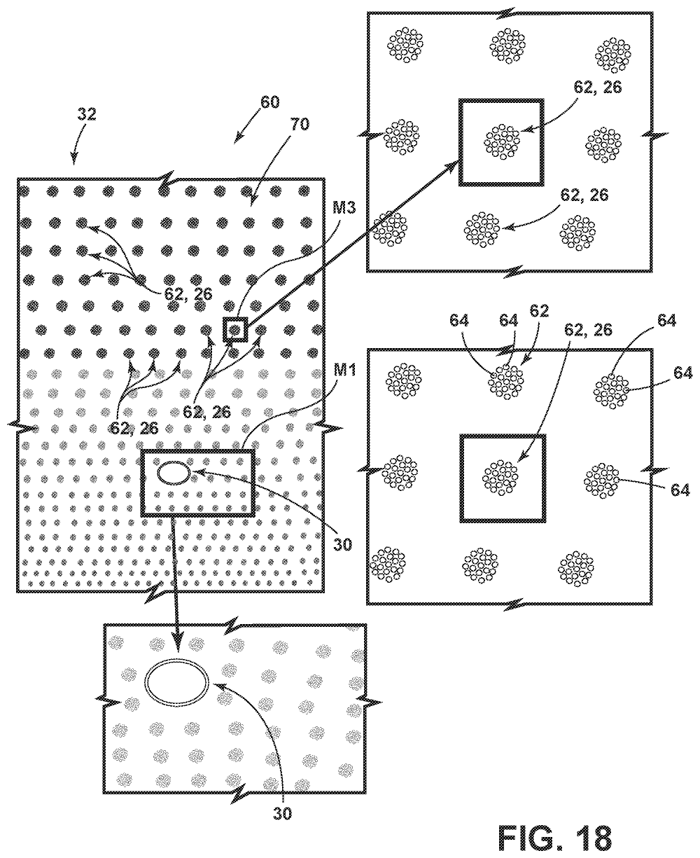

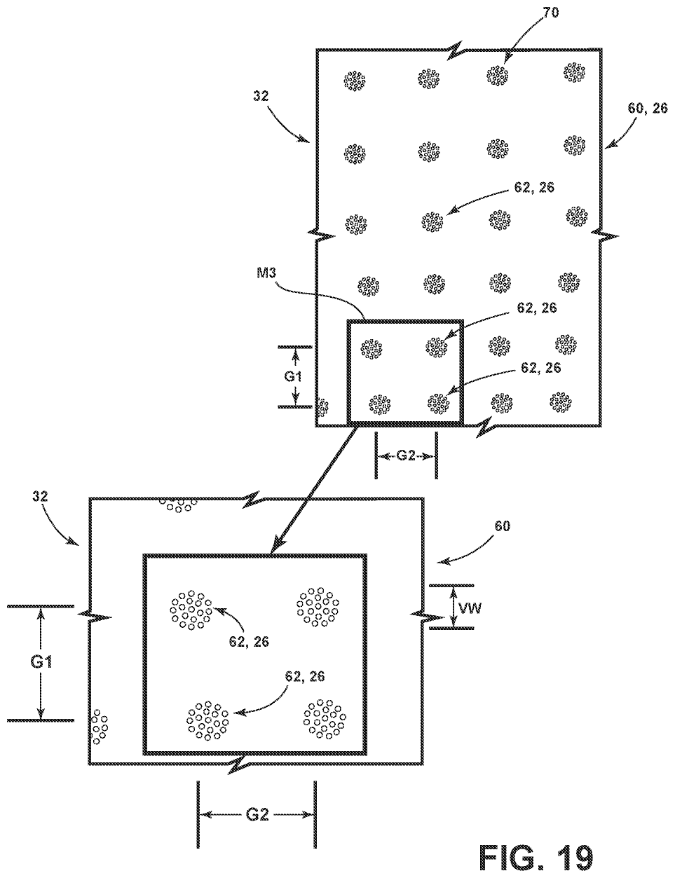

Referring again to FIG. 6, the lower mold half 40 further includes a plurality of steam vents 50 for releasing steam from the mold cavity 46 and for forming protrusion clusters 62 on the exterior skin 70 of the board 100 during molding of the board 100. The plurality of steam vents 50 in the mold halves 40 can include one or more types of steam vents 50, each vent 50 including a plurality of vent openings, such as vent apertures 68 or vent slots 66, which can be of different sizes, as illustrated by the non-limiting examples shown in FIG. 20, selected and arranged in the mold halves 40 to produce protrusion clusters 62 within purchase surface areas 60 distributed on the exterior skin 70 of the board 100, where the number, arrangement, shape, size (width and height) and spacing of the protrusions 64 in each protrusion cluster 62, and the number, arrangement, shape, size and spacing of the protrusion clusters 62 within each purchase surface area 60 define the purchase, gripping and/or frictional characteristics of each respective purchase surface area 60 of the board 100. Referring to FIGS. 15-19, example protrusion clusters 62 formed on the exterior skin 70 of the board 100 during molding are shown. In one example, shown in FIGS. 15, 18 and 19, purchase surface areas 60 formed on the bottom 32 of a board 100 include a plurality of protrusion clusters 62, where in the present example, each of the protrusion clusters 62 is configured as a vent marking 26 formed using a salt and pepper type steam vent 50 including a plurality of vent apertures 68 (see FIG. 20) sized, shaped and arranged to form the arrangement of protrusions 64 (as shown in the magnified sectional view) within a vent marking 26. The term “vent marking 26” is used to describe a specific configuration of a protrusion cluster 62 in the present example, such that it would be understood that the protrusion clusters 62 formed on a board 100 can include different configurations of protrusion clusters 62, including the vent marking 26 shown in FIG. 15 and a microvent marking 24 shown in the example illustrated by FIG. 17. Referring again to FIGS. 15 and 16, the protrusion cluster 62 can be characterized as having a vent width VW which corresponds, in the present example of a vent marking 26, to the width of the cluster of protrusions 64. The protrusions 64 can be characterized, as shown in FIG. 16, in the cross-sectional view of section A-A, as having a protrusion width PW and a protrusion height PH which are defined by the size of the vent aperture 68 in the steam vent 50 and defined by controlling, within predetermined ranges, one or more molding parameters such as temperature, steam pressure, PP bead fill density, etc., or a combination of these, affecting the extrusion of the EPP material 28 into the vent apertures 68. The protrusions 64 can be characterized as having a protrusion spacing PS, shown in the present example as the center-to-center distance between adjacent protrusions 64 within the protrusion cluster 62, where the protrusion spacing PS is defined by the pattern and placement of the vent apertures 68 in the steam vent 50. The protrusion clusters 62 within a purchase surface area 60 may be randomly arranged, e.g., without a defined pattern, or can be arranged to define a specific pattern, as shown in the example illustrated in FIGS. 18 and 19. Referring to FIGS. 18 and 19, shown is a purchase surface area 60 formed on the bottom 32 of the board 100, including a plurality of protrusion clusters 62 configured as vent markings 26, where the vent markings 26, and the steam vents 50 forming the vent markings 26, are arranged and positioned in a grid pattern as shown in FIG. 19, characterized by grid spacing G1, G2, where G1 and G2 may be substantially the same, or can be different. The example shown in FIGS. 18 and 19 is non-limiting, and it would be understood that other patterns, including non-symmetrical, circular, etc. can be formed on the exterior skin 70 to define a purchase surface area 60.

In another example, shown in FIG. 17, purchase surface areas 60 formed on the top deck 34 of a board 100 include a plurality of protrusion clusters 62, where in the present example, each of the protrusion clusters 62 is configured as a microvent marking 24 formed using a salt and pepper microvent type steam vent 50 including a plurality of vent apertures 68 (see FIG. 20) sized, shaped and arranged to form the arrangement of protrusions 64 (as shown in the magnified sectional view) within each microvent marking 24. The term “microvent marking 24” is used to describe a specific configuration of a protrusion cluster 62 in the present example, such that it would be understood that the protrusion clusters 62 formed on a board 100 can include different configurations of protrusion clusters 62, including the microvent marking 24 shown in FIG. 16 and other configurations of protrusion clusters 62, such as the vent markings 26 previously described herein, slotted vent markings, mesh vent markings, etc.

The examples illustrated in the Figures are non-limiting, and it would be understood that combinations of different types and sizes of steam vents 50 can be included in the mold halves 40 and arranged to define various purchase surface areas 60 each characterized by different purchase or gripping properties and performance, as defined by the particular combination of steam vents 50 used to form the protrusion clusters 62 within the respective purchase surface area 60. These protrusions 64 can range in size, shape, spacing, etc., based on which type of steam vent 50 is used and based on the arrangement and size of the vent apertures 66, 68 within the steam vent 50. By way of non-limiting illustration, steam vents 50 used to mold the protrusions 64 described herein can have a diameter in a range from about 4 mm to 15 mm, where the diameter of the vent 50 is directly related to, e.g., defines the vent width VW of the protrusion cluster 62 (see FIG. 15). In a non-limiting example, the steam vents 50 can be arranged in the mold halves 40 such that each vent 50 is spaced from an adjacent vent in a range of about 12 mm to 30 mm on center, where the center to center spacing of the steam vents 50 is directly related to, e.g., defines, the grid spacing G1, G2 of protrusion clusters 62 within a purchase surface area 60 (see FIG. 19). The steam vents 50 can also range in style, including salt and pepper style steam vents 50 with vent apertures 68 ranging in size from about 0.3 mm to 0.9 mm, slotted steam vents 50 including vent slots 66, mesh steam vents, and custom steam vents (see FIG. 20).

In a non-limiting example, it is preferred to use salt and pepper style steam vents 50, each having a vent diameter of 8 mm (defining the vent width VW of a protrusion cluster 62 formed by the steam vent 50) and including vent apertures 68 having an aperture diameter of 0.6 mm (defining the protrusion width PW of protrusions 64 formed within the protrusion cluster 62) in diameter, with the steam vents 50 spaced from each other at 19 mm on center, to form vent markings 26 within purchase surface areas 60 formed on any surface of the board 100, e.g., on either or both of the top deck 34 or bottom 32. These salt and pepper vent markings 26 create excellent purchase that may require the board rider to wear a rash guard or wetsuit to protect the rider's skin from rashes that can be caused by prolonged use in contact with the purchase surface areas 60 including the salt and pepper vent markings 26. Advantageously, these purchase surface areas 60 including salt and pepper vent markings 26 spaced on 19 mm centers eliminate the need for a board user/rider to obtain and/or apply aftermarket purchase enhancing products. Advantageously, these purchase surface areas 60 including salt and pepper vent markings 26 can also act as a base for applied after-market surf waxes, improving retention of the wax to the exterior skin 70 of the board 100.

In a non-limiting example, to have a more aesthetically appealing board and/or for use in warmer water climates where a board rider/user may not possess chafe protective apparel such as a wetsuit or rash guards, it is preferred to form the purchase surface areas 60 of the board 100 including ultra-fine 8 mm salt and pepper microvent markings 24 spaced at 24 mm on center to create ultra-fine protrusions 64 of the type shown in FIG. 17, where the purchase surface areas 60 can be formed on any surface of the board 100, e.g., on either or both of the top deck 34 or bottom 32 of the board 100.

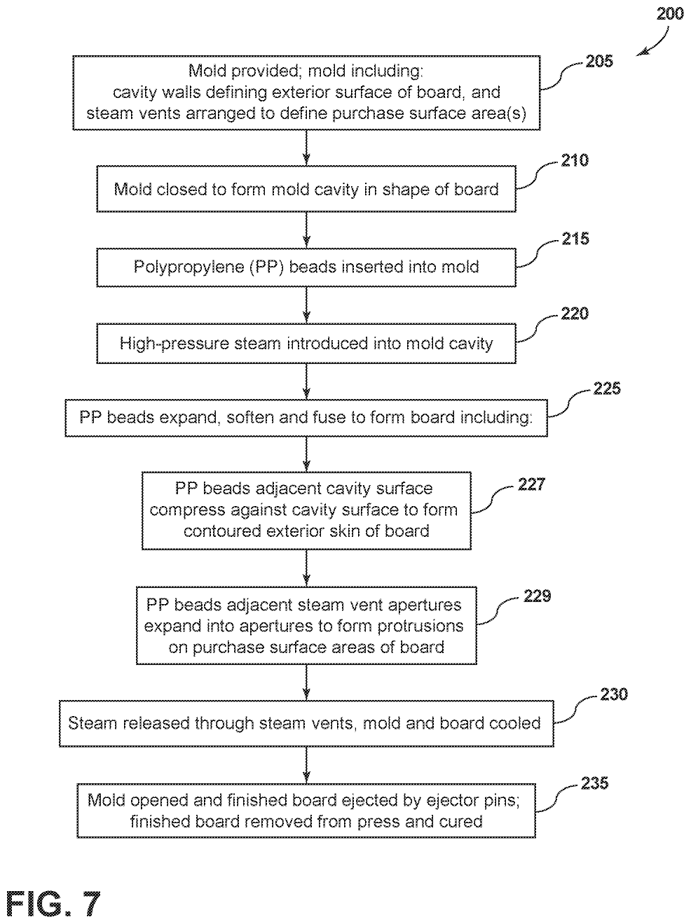

An exemplary method 200 of monolithic construction of the board 100 is illustrated by FIG. 7. The method 200 refers to the molding process shown in FIG. 6, and includes, at step 205 configuring a mold press 58 including providing a mold, in the example consisting of mold halves 40, the mold halves 40 including cavity walls 50 defining the exterior skin 70, the top deck 34, the bottom 32 and the tail 12 including the contoured tail feature 14, of the board 100, such that with the mold halves 40 in a closed condition, the cavity walls 50 form a mold cavity 46. The mold halves 40 further include a plurality of steam vents 50 arranged to form a plurality of protrusion clusters 62 on the exterior skin 70 of the board, the protrusion clusters 62 defining one or more purchase surface areas 60 on the board 100.

At step 210, the mold halves 40 are closed to form the mold cavity 46 in shape of board 100. At step 215, a single homogeneous material, which in the present example is non-expanded polypropylene (PP) beads 38 is inserted into the mold cavity 46 via PP fill nozzles, also referred to herein as PP fill guns 42. In a non-limiting example, the rate of feed and/or volume of PP beads 38 fed into the mold cavity 46 via the PP fill guns 42 is controlled such that the density of the monolithic board 100 after forming and curing is about 1.9 lbs/cu.ft. The non-expanded PP beads 38 are sized such that after expansion and curing, the expanded polypropylene (EPP) beads fused together to form the EPP foam 28 each have a diameter, after expansion, in the range of about 3 mm to 5 mm.

At step 220, high-pressure steam 48 is flowed into the mold cavity 46 via steam nozzles 56. At step 225, the PP beads in reaction to the high-pressure steam, expand, soften and fuse to each other to form expanded polypropylene (EPP) foam 28 in the mold cavity 46, and in the shape of the board 100, such that the board 100 can be described as a monolithic structure and consisting of a single homogeneous material, e.g., the EPP foam 28. Step 225 includes steps 227 and 229, where at step 227, the expanded PP beads which are adjacent and/or in contact with the mold cavity surface 52 are compressed against the cavity surface 52 during expansion, and fuse (heat-bond) to each other to form the contoured exterior skin 70 of the board 100. As shown in FIG. 15, the expanded PP beads fuse together at boundaries defined by the fused surfaces of adjacent expanded PP beads, where the density of the molded board 100, and as such, resistant to water ingression and absorption by the board 100 is determined in part by the degree of fusion at the bead boundaries and the degree of any crannies or crevices residual between the expanded PP beads after fusing, e.g., heat bonding. For example, where the expanded beads are fully fused to each other at the exterior skin 70, with no residual crannies therebetween, a smooth surface is obtained and the resistance to water ingression and absorption by the board 100 is maximized. In contrast, where at the surface of the exterior skin 70 of the board 100 there is a slight residual cranny or crevice due to less than complete fusing of the expanded PP beads at the bead boundary, the exterior skin is texturized by the cranny or crevice formed therein, as shown in FIG. 15, such that the irregular surface at the bead boundary increases the purchase (gripping) capacity of the exterior skin 70 relative to an exterior skin 70 formed of fully fused expanded beads. However, the presence of the crevice or cranny may slightly decrease the resistance of the board 100 to water ingression and/or to water absorption. In a preferred embodiment, the expanded PP beads are fused together to form the EPP foam 28 such that the expanded PP beads each have a diameter, after expansion, in the range of about 3 mm to 5 mm, and are fused together at the exterior skin 70 at very slightly less than complete fusion to texturize the surface of the board 100 while exhibiting very high resistance to water ingression and water absorption.

Continuing at step 227, the expanded PP beads which are adjacent and/or in contact with the mold cavity surface 52 are compressed against the cavity surface 52 during expansion, to form contoured features of the board 100 including a contoured edge rail detail 14, a contoured tail edge feature 18, a debossed logo marking 22, a contoured leash plug hole 20, contoured injector head markings 36, each of which are contoured to increase resistance to cracking and/or water ingression in use and to decrease susceptibility to damage to the exterior skin 70 at these feature locations, and such that in use, the flow of water, snow, sand, etc. over the exterior skin 70 of the board 100 is not affected by and/or is only minimally impeded by the contoured features. Referring to FIGS. 1, 5, 11 and 12, shown is a contoured tail edge feature 18 which includes a contoured surface extending the width of the tail portion 12 which is substantially flat and/or beveled, such that the tail portion is absent of any sharp edges which would be susceptible to breakage and/or damage when the board 100 is in use and/or during transport and/or storage of the board 100, especially when positioned in an upright position as shown in FIGS. 1, 2, 8 and 9. The contoured tail edge feature 18 is configured to provide a substantially flat or beveled resting surface for positioning the board 100 in the upright position as shown in FIGS. 1, 2, 8 and 9, where the flat and/or beveled surface of the contoured tail edge feature 18 prevents deformation to the EPP foam 38 and exterior skin 70 in the tail portion 12 during storage, display, transport, and/or use of the board 100.

At step 227, a contoured edge rail detail 14 is formed at the parting line of the mold halves 40. As shown in FIGS. 2 and 5, the contoured edge rail 14 is beveled and/or recessed to minimize flash formation at the mold parting line during forming of the board 100, such that minimal or no trimming of flash is required. The contoured edge rail detail 14 creates an aesthetically pleasing detail along the side of the board 16, and is contoured to increase resistance to damage along the side of the board 16 in use and/or during transport and storage.

At step 227, as shown in FIGS. 5, 13 and 15, a leash plug hole 20 is formed as a through hole extending through the board height BH, during the molding process 200. The surface defining the plug hole 20 is formed during molding of the board 100, and the transition from the top deck 34 and bottom to the hole is radiused such that the integral plug hole 20 is defined by the exterior skin 70 of the board 100 and as such is resistant to water ingression and impact damage. Forming the plug hole 20 during the molding process is advantaged by eliminating any need for after-market drilling, cutting, or penetration of the board 100 and/or the water resistant exterior skin 70 of the board 100, for example, for installation of a leash or other accessory. This allows the EPP material 28 to maintain the as-formed exterior skin 70 defining the through hole 20 throughout the use of the board 100. The diameter of the plug hole 20 can be any size to accommodate the different variations of plug diameters. The example of a leash plug hole 20 is non-limiting, and it would be understood that other holes and/or recesses can be formed in the board 100 during the molding process, for use in attachment and/or installation of other accessories, such as cameras, leashes, fins, straps, handles, etc., without compromising the integrity of the exterior skin 70 of the board 100 and with the advantage of eliminating after-market drilling, cutting or other penetration of the exterior skin 70 of the board 100 and the related loss of resistance to water absorption.

At step 227, as shown in FIGS. 1 and 13, a debossed appearance feature 22, such as a logo or other decorative or identifying feature, can be formed into the exterior surface 70 of the board 100 during molding. In the present example, the debossed appearance feature 22 is the logo “AHI” debossed into the top deck 34 of the board 10. By debossing the appearance feature 22 during molding of the board 100, continuity and integrity of the exterior skin 70 is maintained for resistance to water ingression, and interference with water flow by the debossed feature 22 is minimized.

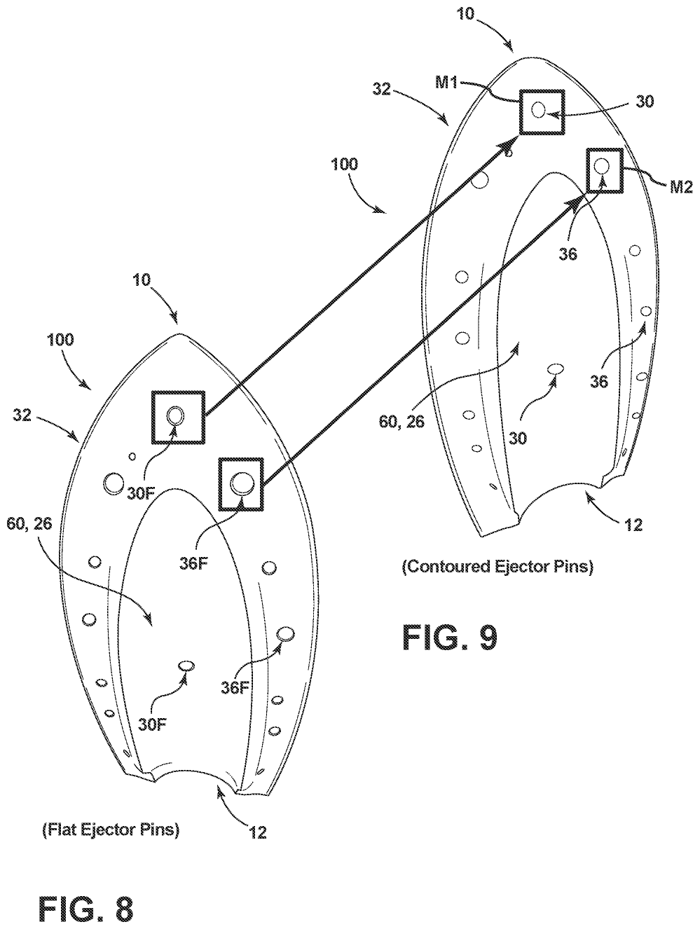

At step 227, contoured injector head markings 36, also indicated in the figures as located in the boxes labeled M2, may form where the bead injector (fill gun) heads 44 interface with the mold cavity surface 52. To minimize and/or substantially avoid the formation of the injector head markings 36, the fill gun heads 44 are contoured to blend to the contour of the mold cavity surfaces 52, such that injector head markings 36, if formed, are minimized as shown in FIGS. 9, 10 and 15. By contrast, FIG. 8 shows a board 100 formed using flat (non-contoured) fill gun heads during the molding process, where the flat fill gun heads extend through the mold cavity surface 52 and into the mold cavity 46 during forming of the board 100, such that the flat fill gun heads form relatively deep pockets in the surface of the board 100, which are not aesthetically pleasing and disrupt water flow over the surface 70 of the board 100. The pockets have sharp edges which can impinge on fluid flow over the board surface 70 and/or be susceptible to cracking or chipping the exterior skin 70 of the board. As such, the use of contoured fill gun heads 44 provides the advantage of minimizing and/or eliminating witness marks being formed on the surface of the board 100.

Referring again to the method 200 shown in FIG. 7, at step 229, in reaction to the steam introduced into the mold cavity 46, the expanding PP beads adjacent and/or in contact with the steam vents 50 protrude during expansion into the vent apertures 68 to form protrusions 64, also referred to herein as vent markings 64, in the exterior skin 70 of the board 100, where a protrusion cluster 62 is formed at each steam vent 50 to define purchase surface areas 60 of the board 100, as described herein.

At step 230, the steam is released through the steam vents 50 and the mold 40 and board 100 formed within the mold cavity 46 is cooled.

At step 235, the mold halves 40 are opened and the finished board 100 if ejected by ejector pin(s) 54 and removed from the mold cavity 46. Similar to the injector fill gun heads 44, the ejector pins 54 are contoured to conform to the exterior shape of the board 100, to minimize any markings to the exterior skin 70 of the board 100 during the forming process. Additionally, the ejector pin pressure can be controlled and/or minimized to minimize formation of an ejector pin marking 30 on the exterior skin 70 during ejection of the board 100 from the mold. Referring to FIGS. 8-10 and 18, FIGS. 9, 10 and 18 show minimal ejector pin markings 30, also indicated in the figures as located in the boxes labeled M1, formed on the exterior surface 70 of the board 100 by the contoured ejector pins 54 during ejection of the board 100 from the mold 40. In contrast, FIG. 8 shows a board 100 ejected from the mold 40 using flat (non-contoured) ejector pins, where the flat ejector pins 54 form witness mark pockets with sharp edges in the surface of the board 100, which are not aesthetically pleasing and which disrupt water flow over the surface 70 of the board 100. The pockets have sharp edges which can impinge on fluid flow over the board surface 70 and/or be susceptible to cracking or chipping. As such, the use of contoured ejector pins 54 provides the advantage of minimizing and/or eliminating witness marks being formed on the surface of the board 100 during ejection of the board 100 from the mold 50.

Continuing with step 235, after removal of the fully formed board 100 from the mold cavity 46, the molded board 100 is cured, for example, by heating the board 100 in an oven to 175 degrees Fahrenheit for about 6 hours. Once cured, the board 100 is ready for its intended use, without further processing.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A sports board comprising:
a monolithic structure composed of a single homogeneous material;
the monolithic structure having a continuous exterior skin including at least one purchase surface area;
the continuous exterior skin including a plurality of cluster protrusions;
the plurality of cluster protrusions defining the at least one purchase surface area.

2. The sports board of claim 1, wherein the single homogeneous material is an expanded polypropylene (EPP) foam.

3. The sports board of claim 1, wherein:
the single homogeneous material is a recyclable material; and
the monolithic structure is recyclable.

4. The sports board of claim 1, each cluster protrusion of the plurality of cluster protrusions including a plurality of vent markings.

5. The sports board of claim 4, wherein the plurality of vent markings include a plurality of domed protrusions.

6. The sports board of claim 4, wherein the plurality of vent markings include a plurality of ridges.

7. The sports board of claim 4, wherein the plurality of vent markings include one of a plurality of microvent markings or a plurality of steam vent markings.

8. The sports board of claim 4, wherein each vent marking of the plurality of vent markings is spaced from an adjacent vent marking of the plurality of vent markings at a range of about 19 mm to 24 mm on center.

9. The sports board of claim 1, wherein the plurality of cluster protrusions are arranged in a pattern within the at least one purchase surface area.

10. The sports board of claim 1, wherein the plurality of cluster protrusions are randomly arranged within the at least one purchase surface area.

11. The sports board of claim 1, further comprising:
the sports board having a board width in a range of about 6 to 18 inches and having a board length in a range of about 6 to 18 inches.

12. The sports board of claim 1, further comprising:
the sports board having a board width in a range of about 20 to 36 inches and having a board length in a range of about 32 to 50 inches.

13. The sports board of claim 1, further comprising:
the sports board having a board width in a range of about 20 to 48 inches and having a board length in a range of about 40 to 10 inches.

14. The sports board of claim 1, further comprising:
the sports board having a board width in a range of about 36 to 72 inches and having a board length in a range of about 60 to 84 inches.

15. The sports board of claim 1, further comprising:
a tail portion including a contoured surface defined by the continuous exterior skin;
wherein the contoured surface is configured as a resting surface for resting the sports board in an upright position.

16. A method of making a sports board, the sports board formed as a monolithic structure composed of expanded polypropylene (EPP) beads, the method comprising:
providing a mold including a mold cavity defined by a cavity wall;
the cavity wall defining a continuous exterior skin of a sports board;
the continuous exterior skin including at least one purchase surface area;
the cavity wall including a plurality of steam vents arranged to define the at least one purchase surface area of the continuous exterior skin;
each steam vent of the plurality of steam vents including a plurality of vent apertures;
filling the mold cavity with polypropylene (PP) beads;
introducing steam into the mold cavity;
expanding and fusing the polypropylene beads in the mold cavity, in reaction to the steam, to form the sports board including the continuous exterior skin;
wherein expanding and fusing the polypropylene beads includes forming the continuous exterior skin including the at least one purchase surface area, by:
compressing the expanding polypropylene beads against the cavity wall; and
protruding the expanding polypropylene beads into the plurality of vent apertures to form a plurality of cluster protrusions;
wherein the plurality of cluster protrusions define the at least one purchase surface area.

17. The method of claim 16, the plurality of steam vents including:
a first plurality of steam vents having vent openings of a first size;
a second plurality of steam vents having vent openings of a second size different from the first size.

18. The method of claim 16, wherein:
each cluster protrusion of the plurality of cluster protrusions including a plurality of vent markings; and
a shape of each vent marking of the plurality of vent markings is defined by a corresponding vent aperture of the plurality of vent apertures.

19. The method of claim 18, wherein each vent marking is characterized by a protrusion size, the method further comprising:
controlling, within a predetermined range, a molding parameter;
wherein the predetermined range corresponds to the protrusion size; and
wherein the molding parameter is one of a molding temperature, a steam pressure, or a PP bead fill density.

20. The method of claim 16, the mold including at least one ejector pin actuable to eject the sports board from the mold cavity by contact of the at least one ejector pin with the continuous exterior skin;
wherein the ejector pin is contoured to conform to the continuous exterior skin such that a ejector marking formed by contact of the at least one ejector pin with the continuous exterior skin is negligible.
